(19) United States
(12) Patent Application Publication
(10) Pub. No.: US 2004/0021306 A1
(43) Pub. Date: Feb. 5, 2004

(54) Gas generator, especially for filling an airbag

(76) Inventor: Peter Lell, Moosburg (DE)

Correspondence Address: Schaffer & Culbertson, Building One Suite 360, 1250 Capital Of Texas Highway South, Austin, TX, 78746, US

(21) Appl. No.: 10/297,882

(22) PCT Filed: Jun. 8, 2001
(86) PCT No.: PCT/DE01/02134

(30) Foreign Application Priority Data
Jun. 9, 2000 (DE) 100 8 168.0

(51) Int. Cl. B60R 21/26

(52) U.S. Cl. 280/736

(57) ABSTRACT

The invention relates to a gas generator, in particular for filling a gas bag, comprising a housing (7, 15, 17, 27) in which a stream of gas can be generated by means of a gas generating material (11) to be activated which is provided in a combustion chamber (3), which stream of gas escapes from an outlet opening (45) of the housing, and comprising a removing device (33; 47) for removing solid or liquid particles produced during the generation of gas, through which the gas stream generated flows. According to the invention, the stream of gas or a partial stream of gas is deviated from its direction of flow in the removing device (33; 47) at least once in a sufficiently narrow radius of curve and by a sufficiently large angle in such a way that the particles leave the stream of gas or the partial stream of gas, with a rebounding portion (37, 43; 51a, 53a) and/or a removing portion (51b, 53b) being provided substantially in the prolonged direction of flow, which is hit by the particles entrained in the stream of gas, or into which the particles penetrate. The particles burst to form smaller particles as a result of the impact on the rebounding portion (37, 43; 51a, 53a) and/or penetrate into it and/or are at least partially retained in the removing portion (51b, 53b).

The invention relates to a gas generator, in particular for filling a gas bag, having the features of the preamble of patent claim 1.

Gas generators are known in various embodiments. For specific fields of application, hybrid gas generators in particular are used. In this type of gas generator, a gas generating material contained in a combustion chamber is activated by means of an igniter. This material is usually a pyrotechnic propellant charge, which bums off after having been ignited and thereby generates gas. In this type of gas generation, a propellant gas is produced which is interspersed with solid or liquid particles which are produced when the propellant charge is burnt off. In hybrid gas generators, the propellant gas can actuate a device which opens a gas vessel in which pressurized stored gas is contained. The stored gas may be argon with a small portion of helium, for example. The mixture of the propellant gas and the stored gas contained in the gas vessel escapes at the outlet opening of the hybrid gas generator and may serve to fill a gas bag, for example.

In order not to damage the gas bag, which may also be a critical element with regard to safety, such as an air bag for an automotive vehicle, while filling it, it is necessary to retain the solid or liquid particles in the gas generator which have been produced when burning off the propellant charge. For this purpose, it is known to use a filter element in the area of the one or several outlet openings of the gas generator.

For example, a hybrid gas generator is known from the document DE 196 02 009 A1 in which a filter element is arranged in the area of several outlet openings which are provided in a filter chamber housing and which are arranged radially with respect to the longitudinal axis of the gas generator. The gas escaping passes through the filter element and is thereby cleared from particles.

From the document EP 0 669 231 A2, too, a hybrid gas generator for filling a gas bag is known in which a filter element is provided in the area of several outlet openings, which consists of a trellis, a braided material or a nonwoven fiber material and is manufactured from a suitable material such as metal or ceramics.

These generally known filter elements have the disadvantage of a high flow resistance to the gas penetrating through them. Furthermore, the sieves which can be used are very expensive. Thus, a correspondingly high pressure has to be generated inside the gas generator if a predetermined volumetric flow rate of gas is to be generated in the short time span. In turn, a high pressure has the disadvantage that the housing has to be designed to resist high pressures correspondingly, which leads to a higher weight and higher manufacturing costs of the gas generator.

Taking this prior art as a basis, the object of the invention is to provide a gas generator, in particular for filling a gas bag, which comprises a particle retention or removing device, which has a sufficient particle removing effect on the one hand and a low flow resistance on the other hand.

The invention achieves this object with the features of patent claim 1.

The invention is based on the idea that, by deviating the stream of gas or several individual partial streams of gas by a sufficient angular amount and sufficiently narrow radii of curves, particles cannot follow the stream of gas any more because of their higher inertia of masses and can thereby be extracted from the stream of gas.

According to the invention, at the position where the particles leave the stream of gas or the partial stream of gas, a rebounding or impact portion and/or a removing portion is provided. The rebounding portion is designed such that the particles hitting it burst to form smaller particles as a result of the impact. The removing portion is configured such that the particles, which may have burst, are retained in the removing portion.

In one embodiment of the invention, the stream of gas can be deviated several times in the removing device, possibly after it has been divided into several partial streams of gas. Here, at several deviating positions or all deviating positions, a rebounding portion and/or a removing portion may be provided. Deviating the stream several times and providing rebounding portions and/or removing portions, which are arranged one behind the other, respectively, results in improved clearing efficiency.

In a further embodiment of the invention, the rebounding portion may consist of a material, preferably a plastics material, which makes it possible for solid or liquid particles of high kinetic energy to penetrate into the material. Hereby, particles are permanently removed from the stream of gas.

According to a different embodiment of the invention, the removing portion may comprise a recess in which the particles deposit. The recess is preferably configured such that particles present in the recess are not transported out of the recess and back into the stream of gas again as a result of whirling generated in the recess or in the area of the recess.

The removing device may comprise a shielding element which is provided in front of an inlet opening or outlet opening for the gas stream at a predetermined distance thereto in the direction of the stream of gas. The shielding element protects the inlet opening or the outlet opening from gas flowing directly into it or from particles directly entering it by means of a rebounding portion. Here, the stream of gas has to be deviated from its original direction between the shielding element and the inlet or outlet opening. At the point where the gas stream is deviated, it is again possible to extract the particles.

In a further embodiment, the shielding element comprises through-holes through which the entire stream of gas passes. The cross-section of the through-holes is preferably chosen to be such that they have a filtering function with respect to the particles.

The portion surrounding the inlet opening or outlet opening and/or the rebounding portion of the shielding element, which are hit by particles, preferably consist of a material into which some of the particles penetrate and are trapped and from which some of the particles, which may also have burst upon hitting the portions, rebound. This contributes to improving the clearing effect of the removing device.

The aforesaid embodiment of a removing device which comprises a shielding element is particularly suitable for being arranged in a high pressure portion of the stream of gas, for example in the combustion chamber of a gas generator in front of the outlet opening of the combustion chamber.

According to a further embodiment of the invention, the removing device may comprise several successive, preferably disk-like elements, with these elements comprising through-openings, respectively, and being configured or arranged relative to one another in such a way that the stream of gas is deviated, respectively, at least between the elements. This embodiment makes it possible to give the removing device a cascade-like configuration. Hereby, a simple structure and a cost-efficient assembly are made possible.

For example, merely two types of elements can be arranged preferably coaxially one behind the other, respectively.

The first type of the elements may comprise a centric through-hole or a centric passage with several or a plurality of through-holes. The second type of the elements may comprise a centric rebounding portion and/or removing portion and/or several through-holes, which are displaced radially outwardly in the radial direction relative to the centric through-hole or the centric passage of the first type of the elements. As a result, the stream of gas is deviated between the two types of elements, respectively, from an axial-centric direction into several partial streams of gas which flow through the radially outwardly displaced through-holes of the second types of the elements.

The first type of the elements comprises one or several removing portions and/or rebounding portions preferably in the area of the prolongation of the direction of flow of the gas through the radially outwardly displaced through-holes of the second type of the elements.

The through-holes of the second type of the elements are preferably arranged along a coaxial circular line, and the removing portions and rebounding portions of the first type of the elements are preferably configured as a circumferential groove. This makes a more simple manufacture of the two types of elements possible.

This type of a cascaded removing device is particularly suitable for being used in a low pressure portion of a gas generator, for example in front of the gas outlet opening of a hybrid gas generator.

Further embodiments of the invention are apparent from the subclaims.

In the following, the invention is explained in greater detail with the aid of embodiments illustrated in the drawings, in which

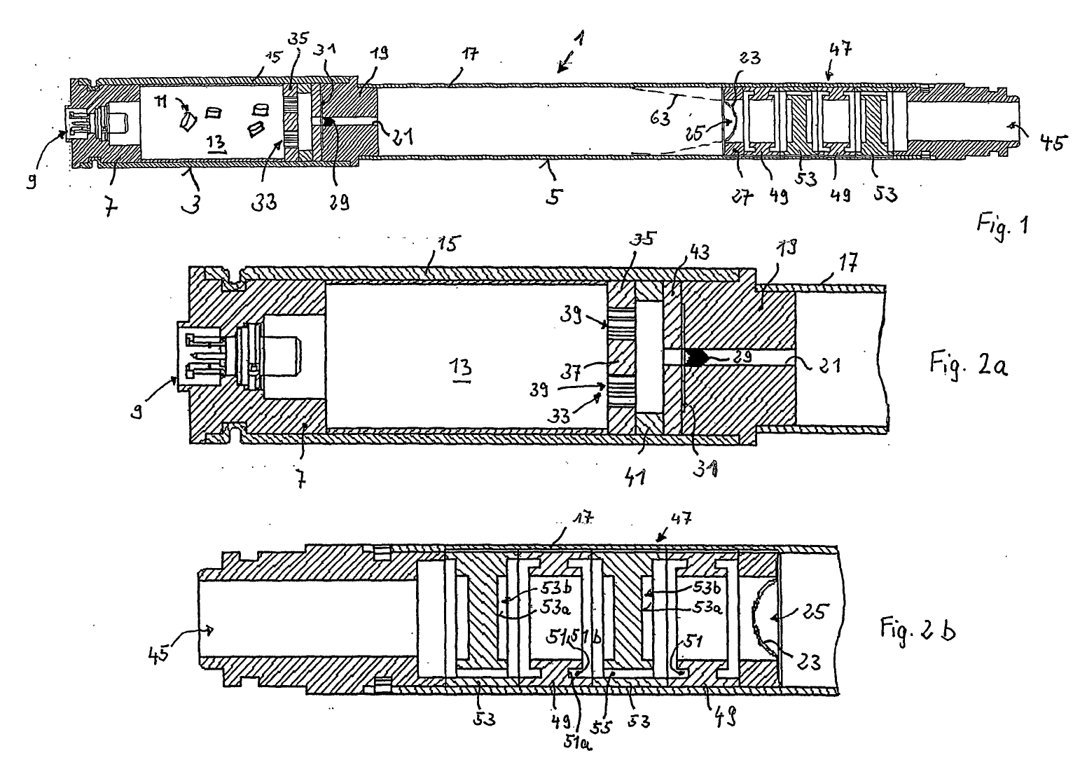

FIG. 1 shows the longitudinal section of a first embodiment of a hybrid gas generator according to the invention; and

FIG. 2 shows enlarged illustrations of the rear (FIG. 2a) and the front (FIG. 2b) portions of the embodiment according to FIG. 1.

The hybrid gas generator 1 shown in FIG. 1 comprises a combustion chamber 3 and a gas vessel 5. At its rear end, the combustion chamber 3 is closed by a disk-like stopper 7; in the stopper 7, an activating device 9 for activating a gas generating material 11, which is contained in the interior space 13 of the combustion chamber 3, is arranged. The activating device 9 is preferably configured as an igniter which can be triggered by means of an electric signal. The axially extending wall of the combustion chamber 3 is preferably configured as a tube section 15, as is shown in FIG. 1.

The gas vessel 5, whose axially extending outer wall may be configured as a tube section 17, too, is connected with a disk-like end piece 19 at its rear end facing the combustion chamber 3; in the end piece, a guide channel 21 is formed, preferably extending along the axis of the tube section 17. The end piece 19 is connected with the front end of the tube section 15 of the combustion chamber 3, too. Connecting the stopper 7 and the end piece 19 with the tube sections 15 or 17 may be effected by welding, for example. These elements may consist of metal or a suitable plastic material. Instead of the multi-component construction shown in FIG. 1, the elements mentioned can of course also be completely or partially formed as one piece.

Forming the combustion chamber 3 with a plastic housing has the advantage that it is easy and cost-efficient to manufacture. The combustion chamber may also be formed as an exchangeable cartridge which may be detachably connected with the gas vessel 5. As the plastic material for the above-mentioned elements which may consist of plastics, PEEK or PE are particularly suitable. PEEK is a very heat-resistant plastic material, which, however, is relatively expensive. Although PE is less heat-resistant in the long run, it has an effect of self-protection if it is heated for a relatively short time: as a result of heating, part of the surface of the PE, which also has a relatively high proportion of water, evaporates. This produces a cooling effect (transpiration cooling) which protects the material from being destroyed at least for a short time.

In the front end portion of the gas vessel 5, an outlet membrane 23 is provided which sealingly closes an outlet opening 25 of the gas vessel 5. In the embodiment illustrated, the outlet membrane 23 is held in a disk-like closure element 27 which is arranged in the front end portion of the tube section 17 of the gas vessel 5 and is sealingly connected therewith. The closure element 27 in its turn may consist of metal or plastics and may be welded to the tube section 17 or may integrally be formed therewith. The outlet membrane 23 is preferably arranged at the inner front wall of the closure element 27 and is sealingly connected with this wall by welding, for example.

In the embodiment shown in FIG. 1, a separate projectile 29 is provided in the guide channel 21 of the end piece 19 of the gas vessel 5. The projectile 29 is preferably held in the guide channel 21 by small frictional forces so that it cannot fall out of the guide channel 21 when the gas generator 1 changes its position. On the rear face surface of the end piece 19, an outlet membrane 31 of the combustion chamber is provided. This membrane may consist of metal or plastics and is sealingly connected with the end piece consisting of metal or plastics preferably by a ring-shaped weld which extends around the cross-section of the guide channel 21. In the interior space 13 of the combustion chamber 3, a first particle retention or removing device 33 is provided in front of the opening of the guide channel 21 which is closed by the outlet membrane 31 of the combustion chamber. The particle removing device 33 comprises a disk-like shielding element 35 which contains a rebounding portion 37. The rebounding portion 37 covers the opening of the guide channel 21 covered by the membrane 31 so as to avoid that solid or liquid particles produced when gas is generated in the interior space 13 of the combustion chamber 3 directly penetrate into the guide channel 21 or that the particles hit the membrane 31 in the area of the opening of the guide channel 21. In order to make it possible for the gas generated in the combustion chamber 3 to penetrate into the gas vessel 5 through the guide channel 21, the shielding element comprises through holes 39 and is arranged in front of the membrane 31 or the opening of the guide channel 21 at a predetermined distance. Because of the finite thickness of the shielding element 5 or the finite length of the through-holes 39, the stream of particles flowing through them cannot hit the membrane 31 directly in the area of the opening of the guide channel 21 or enter into the guide channel 21. The through holes can be chosen to have such a small cross-section that a filtering function is achieved at the same time.

In the embodiment illustrated in FIGS. 1 and 2, in order to obtain a defined distance between the shielding element 35 and the end piece 19, a spacer ring 41 and a rebounding plate 43 are used, which contains a centric opening aligned with the guide channel 21 in the end piece 19.

The rebounding plate 43 consists of a material which makes the particles passing through the through holes 39 of the shielding element 35 burst when they hit the plate so that they obtain a size that does not pose a problem, or the material is made such that those particles which do not burst penetrate into the rebounding plate 43 and are trapped thereby.

The particle removing device 33 thus ensures that the membrane 31 is not destroyed by, solid or liquid particles before a specific threshold pressure is reached. Furthermore, the particle removing device 33 avoids that high-energy particles pass through the guide channel 21.

In the following, the function of the hybrid gas generator shown in FIGS. 1 and 2 is briefly explained: After the activating device 9 has been activated or a corresponding igniter has been ignited, the gas generating material 11 contained in the interior space 13 of the combustion chamber 3 is activated. The generation of gas causes an increase in pressure in the interior space 13. With respect to its thickness and its material, depending on the cross-section of the guide channel 21, the outlet membrane 31 of the combustion chamber is dimensioned such that the membrane is destroyed in the area of the cross-section of the guide channel 21 at a predetermined threshold pressure within very exacting tolerances. This destruction may be a simple bursting of the membrane 31. The projectile 29 held in the guide channel 21 is suddenly acted upon by the corresponding threshold pressure after the membrane 31 has been destroyed. Hereby, the projectile 29 is accelerated in an extremely defined manner and is guided in the guide channel 21 over the entire barrel length until it exits from the guide channel. The barrel length is defined as the length of the guide channel 21 through which the projectile passes from its starting position in the guide channel 21 until it exits from the guide channel 21. Apart from other factors (pressure acting upon the projectile, mass of the projectile, etc.), the barrel length determines the final speed of the projectile 29 when it exits from the guide channel 21.

In order to ensure that the projectile 29 is accelerated in an optimal way, the projectile is preferably formed such that the outer wall of the projectile 29 forms a substantially sealing closure with the inner wall of the guide channel 21. For this purpose, the projectile 29 may comprise a recess in its rear portion so that the residual outer walls in the area of the recess are acted upon by the pressure of the gas generated and are pressed against the inner wall of the guide channel 21. This results in a sealing effect without substantially decelerating the projectile in the guide channel 21 because of inadmissibly high frictional forces and without requiring an additional sealing device or additional sealing means such as an O-ring for the projectile.

The projectile 29 is ejected from the guide channel 21 with a predetermined final speed and flies towards the destructible outlet membrane 23, which it destroys when it hits it. As a result, a mixture of the stored gas contained in the gas vessel 5 and the gas generated in the combustion chamber 3, which flows into the gas vessel 5 when the projectile 29 exits from the guide channel 21, escapes from the outlet opening 45 of the gas generator 1. The mass flux of the gas mixture escaping from the outlet opening 45 as a function of time depends on the pressure in the interior space of the gas vessel 5, which in turn depends on the flow resistance between the outlet opening 25 of the gas vessel 5 and the outlet opening 45 of the gas generator 1 as well as the mass flux of the gas generated which enters into the interior space of the gas vessel 5 through the guide channel 21. The maximum pressure in the combustion chamber 3 may be 700 to 1.500 bar, for example, and the maximum pressure in the interior space of the gas vessel 5 may be 300 to 400 bar. For this reason, it is possible to form the outer walls of the gas vessel 5 to be clearly thinner or weaker than the outer walls of the combustion chamber 3.

For safety reasons, the outlet membrane 23 may be dimensioned such that it is destroyed when a predetermined critical pressure is exceeded and unblocks the outlet opening 25. A situation of this kind may occur in case of malfunction of the gas generator or a false assembly of the generator without the projectile 29, for example. The critical pressure at which the membrane 23 is destroyed is appropriately higher than the normal maximum working pressure which is generated inside the gas vessel 5 if the gas generator functions correctly.

In the front portion of the gas generator 1, a second particle removing device 47 is provided. This device comprises several disk-shaped elements which have the effect that the stream of gas escaping is deviated, respectively. In the embodiment illustrated, the second particle removing device is formed of two different types of disk-like elements. A first type of the disk-like elements 49 is substantially formed by a ring whose centric through opening 49a allows the stream of gas including the particles still existing therein to pass through it axially. In the walls on the front side of the disk-like elements 49, annular grooves 51 are formed. As will be explained later, the annular grooves 51 form removing recesses for solid or liquid particles hitting the surfaces of the grooves. The second type 53 of the disk-like elements does not have a centric through opening, but several through openings 55 positioned radially outwardly. When a disk-like element 53 is seen in a plan view, the radially outward through-holes may be formed as several bores arranged on a circular line.

As illustrated in FIGS. 1 and 2b, after the outlet membrane 23 has been destroyed, the stream of gas first passes through one disk-like element 49 or its centric through-hole 49a and then hits the centric portion of a disk-like element 53 arranged behind the first one, which only comprises through-holes 55 which are displaced radially outwardly. This first disk-like element 53 simultaneously serves to catch the projectile 29.

The stream of gas is therefore deviated from its at first substantially axial path into a substantially radial direction and passes through the through-holes 55 of the disk-like element 53 displaced radially outwardly. The centric portion of the disk-like elements 53 may again be formed as a rebounding portion 53a, as has already been described in connection with the rebounding portion 43. Furthermore, the rebounding portion 53a may be provided at the bottom of a recess so that the recess has the effect of a removing portion 53b in which particles may deposit. Having passed through the through-holes 55 of the disk-like element 53, the stream of gas has to be deviated again (two times) in order to be able to pass through the centric through opening 49a of the second disk-like element 49 in a substantially axial direction again The cross-section of the through-holes 55 may be chosen such that a filtering function is achieved at the same time. When the stream of gas is deviated from the parallel-axial direction when it passes through the through-holes 55 of the disk-like element 53 into a substantially radially inward direction, particles are trapped in the annular groove 51 of the second disk-like element 49, as the particles cannot follow the rapid deviation of the gas stream, at least if they exceed a certain mass. The interior space of the annular groove 51 thus serves as a removing portion 51a. At least the inner wall at the front side of the annular groove 51 or the entire element 49 can consist of a material which allows high-energy particles to penetrate into it and catches them or makes the particles hitting the material burst. Thus, the annular groove 51 simultaneously forms a rebounding portion 51a and a removing portion 51b. Instead of an annular groove 51, which serves as a common rebounding portion or removing portion for all through-holes 55, separate rebounding portions or removing portions may of course be assigned to each through-hole or several through-holes, respectively.

In the embodiment shown in FIGS. 1 and 2, the stream of gas passing centrically through the second disk-like element 49 is again deviated in such a way that it can pass through the radially outward through-holes 55 of the second disk-like element 53. The centric portion of the element 53 again serves as a rebounding portion 53a and a removing portion 53b. Having passed through the through-holes 55 of the second disk-like element 53, the stream of gas leaves the gas generator 1 through the centric outlet opening 45 in the front portion of the gas generator 1. The gas generator 1 may be formed such that a gas bag to be inflated, e.g. an air bag, may be mounted therein.

Instead of large centric through-holes in the disk-like elements 49, a plurality of small through-holes may also be provided in this area which act as a filter, or a sieve-like element may be inserted in the centric through-hole.

The embodiment of a particle removing device 47 illustrated in FIGS. 1 and 2 has the advantage that it is made of only two different components (the disk-like elements 49 and 53). Apart from the advantage of a cost-efficient realization, this results in a simple assembly which is not susceptible to failure.

Of course, however, the particle removing device 47 just like the particle removing device 33 may also be realized in arbitrary other ways; in any case, it is necessary that the stream of gas containing the particles is deviated at least once, and at least one rebounding portion and/or removing portion is required, which is provided substantially in the elongated direction of the stream of gas before it is deviated.

A further remark that may be made in this context is that the barrel length for a projectile 29 guided in the guide channel 21 should be at least one time the diameter of the projectile in order to achieve sufficient guidance.

In the gas generator according to the invention, if the guide channel or barrel has corresponding dimensions, it has the additional effect that a narrow, sharply limited jet of gas is created which enters into the gas vessel from the combustion chamber. By suitably dimensioning the guide channel, the length of the club-like jet and the diameter thereof as well as the opening angle of the jet can be determined in such a way that the gas escaping from the combustion chamber and the stored gas contained in the gas vessel are mixed through well. The ratio of the diameter or cross-section of the guide channel and the diameter or cross-section of the gas vessel is preferably in the range of 1/10 to ⅕.

1. A gas generator, in particular for filling a gas bag,
a) comprising a housing (7, 15, 17, 27) in which a stream of gas can be generated by means of a gas generating material (11) to be activated which is provided in a combustion chamber (3), which stream of gas escapes from an outlet opening (45) of said housing, and
b) comprising a removing device (33; 47) for removing particles produced during the generation of gas, through which the gas stream generated flows,
characterized in that
c) said stream of gas or a partial stream of gas is deviated from its direction of flow in said removing device (33; 47) at least once in a sufficiently narrow radius of curve and by a sufficiently large angle in such a way that the particles leave the stream of gas or the partial stream of gas,
d) that a rebounding portion (37, 43; 51a, 53a) and/or a removing portion (51b, 53b) is provided substantially in the prolonged direction of flow, which is hit by the solid or liquid particles entrained in the stream of gas, or into which the particles penetrate,
e) wherein the particles burst to form smaller particles as a result of the impact on the rebounding portion (37, 43; 51a, 53a) and/or penetrate into it and/or are at least partially retained in the removing portion (51b, 53b).

2. A gas generator according to claim 1, characterized in that said stream of gas or partial stream of gas is deviated by an angle of larger than or equal to 45°, preferably larger than or equal to 80°.

3. A gas generator according to claim 1 or 2, characterized in that said stream of gas is deviated several times in said removing device (33; 47) and that a rebounding portion (37, 43; 51a, 53a) and/or a removing portion is provided at several deviating positions or each deviating position.

4. A gas generator according to one of the preceding claims, characterized in that said rebounding portion (37, 43; 51a, 53a) consists of a material, preferably a plastics material, which makes it possible for solid or liquid particles, particularly hot particles, of high kinetic energy to penetrate into it, wherein said material preferably melts open and retains the particles that have penetrated into it.

5. A gas generator according to one of the preceding claims, characterized in that said removing portion (51b, 53b) comprises a recess in which said particles deposit.

6. A gas generator according to one of the preceding claims, characterized in that the removing device (33) comprises a shielding element (34) which is provided in front of an inlet opening or outlet opening for the gas stream at a predetermined distance thereto in the direction of the stream of gas and which protects the inlet opening or the outlet opening from gas flowing directly into it or from particles directly entering it by means of a rebounding portion (37), the stream of gas being deviated from its original direction in order to enter into the gap between the shielding element (35) and the inlet or outlet opening.

7. A gas generator according to claim 6, characterized in that said shielding element (35) comprises through-holes (39) through which the entire stream of gas passes, with the cross-section of said through-holes preferably chosen to be such that they have a filtering function with respect to the particles.

8. A gas generator according to claim 6, characterized in that at least the portion (43) surrounding said inlet opening or outlet opening and/or the rebounding portion (37) of the shielding element (35), which are hit by particles, consist of a material into which some of the particles penetrate and are trapped and from which some of the particles, which may also have burst upon hitting the portions, rebound.

9. A gas generator according to one of the preceding claims, characterized in that said removing device (33) is arranged in front of an outlet opening of the combustion chamber (3).

10. A gas generator according to one of claims 1 to 5, characterized in that the removing device (47) comprises several successive, preferably disk-like elements (49, 53), said elements (49, 53) comprising through-openings (49a, 55), respectively, and being configured or arranged relative to one another in such a way that the stream of gas is deviated, respectively, at least between said elements (49, 53).

11. A gas generator according to claim 9, characterized in that said elements (49, 53) are coaxially arranged one behind the other.

12. A gas generator according to claim 11, characterized in that two types of elements (49, 53) are alternately arranged one behind the other.

13. A gas generator according to claim 13, characterized in that the first type of elements (49) comprises a centric through-hole (49a) or a centric passage with several or a plurality of through-holes and that the second type of elements (53) comprises a centric rebounding portion (53a) and/or removing portion (53b) and one or several through-holes (55), which are displaced radially outwardly in the radial direction relative to the centric through-hole (49a) or the centric passage of the first type of elements (49).

14. A gas generator according to claim 13, characterized in that said first type of elements (49) comprises one or several removing portions (51b) and/or rebounding portions (51a) in the area of the prolongation of the direction of flow of the gas through the radially outwardly displaced through-holes (55) of said second type of elements.

15. A gas generator according to claim 14, characterized in that said through openings (55) of said second type of elements (53) are arranged along a coaxial circular line and that said removing portions (51b) of said first type of elements (49) are preferably configured as a circumferential groove (51).

16. A gas generator according to one o claims 10 to 15, characterized in that said rebounding portions (51a, 53a) of said elements (49, 53), which are hit by solid or liquid particles, consist of a material into which some of the particles penetrate and are trapped and from which some of the particles, which may also have burst upon hitting the portions, rebound.

17. A gas generator according to one of claims 10 to 16, characterized in that said removing device (47) is arranged in a low pressure portion of the stream of gas, preferably in front of the gas outlet opening (45) of a hybrid gas generator (1).
